(19) United States
(12) Patent Application Publication
(10) Pub. No.: US 2024/0184072 A1
(43) Pub. Date: Jun. 6, 2024

(54) OPTICAL FIBER CABLE HAVING TENSILE STRANDS EMBEDDED WITHIN CABLE JACKET

(71) Applicant: CORNING RESEARCH & DEVELOPMENT CORPORATION, Corning, NY (US)

(72) Inventors: Mark Hanson Bushnell, Hickory, NC (US); Michael Alexander Heinz, Berlin (DE); Eric Raymond Logan, Huntersville, NC (US); Gerhard Gernot Merbach, Neustadt bei Coburg (DE); Waldemar Stöcklein, Coburg (DE)

(21) Appl. No.: 18/437,669

(22) Filed: Feb. 9, 2024

Related U.S. Application Data
(63) Continuation of application No. PCT/US2022/042306, filed on Sep. 1, 2022.
(60) Provisional application No. 63/246,414, filed on Sep. 21, 2021.

(51) Int. Cl. G02B 6/44; G02B 6/38

(52) U.S. Cl. CPC G02B 6/4432; G02B 6/3857; G02B 6/3869; G02B 6/4484

(57) ABSTRACT

Disclosed herein are embodiments of a cable assembly including an optical fiber cable connectorized at one or both ends. The optical fiber cable of the cable assembly includes a cable jacket having an inner surface and an outer surface. The inner surface defines a central bore extending along a longitudinal axis of the optical fiber cable, and the outer surface defines an outermost surface of the optical fiber cable. At least one tensile strand is disposed between the inner surface and the outer surface of the cable jacket, and at least one optical element is disposed within the central bore of the cable jacket. Also disclosed herein are a method of preparing a cable assembly by attaching a connector to the optical fiber cable as and a method of preparing the optical fiber cable.

### PRIORITY APPLICATION

This application is a continuation of International Patent Application No. PCT/US2022/42306, filed Sep. 1, 2022, which claims the benefit of priority of U.S. Provisional Application No. 63/246,414, filed on Sep. 21, 2021, the content of which is relied upon and incorporated herein by reference in its entirety.

### BACKGROUND

The present invention generally relates to a cable assembly and more particularly to an optical fiber cable having tensile strands embedded within a cable jacket of the cable.

Optical fibers are used to transmit data between various points in a fiber optic network. Depending on the distance traveled and the amount of data transmitted, optical fiber cables can vary significantly in size, construction, number of optical fibers, and manner of connection to nodes in the network. For example, some optical fiber cables include thousands of optical fibers arranged in bundles of ribbons that run several kilometers, whereas other optical fiber cables may include only a single optical fiber and extend less than a meter.

### SUMMARY

According to an aspect, embodiments of the present disclosure relate to a cable assembly. In one or more embodiments, the cable assembly includes an optical fiber cable. In one or more such embodiments, the cable assembly includes a cable jacket having a length, an inner surface, and an outer surface. In some embodiments, the inner surface defines a central bore extending along a longitudinal axis of the optical fiber cable, and the outer surface defines an outermost surface of the optical fiber cable. Further, in some embodiments, at least one tensile strand is disposed between the inner surface and the outer surface of the cable jacket, wherein the at least one tensile strand has a length that is substantially equal to or greater than the length of the cable jacket, and at least one optical element is disposed within the central bore of the cable jacket.

According to another aspect, embodiments of the present disclosure relate to a method of preparing a cable assembly. In one or more embodiments of the method, at least one optical element of an optical fiber cable is inserted through a connector housing. In some such embodiments, a first ring section of a crimp band is connected a sleeve of the connector housing, and a second ring section of the crimp band is connected to a cable jacket of the optical fiber cable. Further, in some embodiments, at least one tensile strand is embedded within the cable jacket, and the cable jacket has a length and defines a central bore of the optical fiber cable in which the at least one optical element is disposed.

According to still another aspect, embodiments of the present disclosure relate to a method of preparing an optical fiber cable. In one or more embodiments of the method, a cable jacket and at least one tensile strand is extruded around at least one optical element such that the at least one tensile strand is embedded within the cable jacket. In some such embodiments, the at least one tensile strand is at least one of basalt, a glass, a polyester, an ultra high molecular weight polyethylene, or a polymer having an elastic modulus of at least 30 GPa. Further, in some such embodiments, the cable jacket has an outer surface defining an outermost surface of the optical fiber cable and a maximum cross-sectional dimension of the optical fiber cable in which the maximum cross-sectional dimension is 5 mm or less.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 depicts a cable assembly including a connectorized optical fiber cable, according to an exemplary embodiment;

FIG. 2 depicts a cross-section of the optical fiber cable of the cable assembly taken transverse to a longitudinal axis of the optical fiber cable, according to a first exemplary embodiment;

FIG. 3 depicts a cross-section of the optical fiber cable of the cable assembly taken transverse to a longitudinal axis of the optical fiber cable, according to a second exemplary embodiment;

FIG. 4 depicts a cross-section of the optical fiber of the cable assembly taken transverse to the longitudinal axis of the optical fiber cable, according to a third exemplary embodiment;

FIG. 5 depicts a sectional view of a connectorized end of an optical fiber cable, according to an exemplary embodiment; and

FIG. 6 depicts a sectional view of connectorized end of an optical fiber cable, according to another exemplary embodiment.

### DETAILED DESCRIPTION

Referring generally to the figures, various embodiments of an optical fiber cable having tensile strands embedded in the cable jacket are disclosed. The tensile strands facilitate faster connectorization of the optical fiber cable using less expensive materials that also improve flame test performance. Conventional cable designs utilize a layer of aramid yarns between an optical fiber and the cable jacket to provide tensile strength and shear insensitivity, especially at the connectorization location. However, such aramid yarns are relatively expensive and produce corrosive gases when exposed to flame. According to the present disclosure, alternative materials, such as basalt, glass, polyester, and ultra high molecular weight polyethylene, are used as tensile strands, and the strands are embedded in the cable jacket to provide a buffer against shear stresses. Besides reducing cost and improving flame test performance, the change in cable construction reduces the number of steps that need to be performed for connectorization because a separate layer of tensile strands does not need to be managed during connectorization, These and other aspects and advantages will be discussed in relation to the embodiments provided below and in the drawings. These embodiments are presented by way of illustration and not by way of limitation.

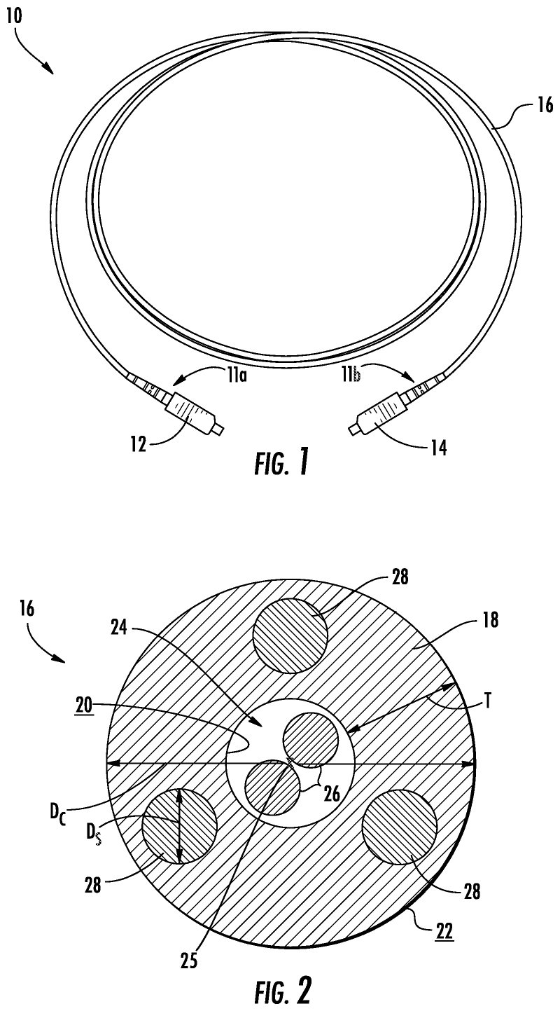

FIG. 1 depicts an embodiment of a cable assembly 10. In one or more embodiments, the cable assembly 10 is connectorized at least one end 11a or 11b. In the embodiment shown in FIG. 1, the cable assembly 10 is connectorized at both ends 11a, 11b. As used herein, the term “connectorized” refers to an embodiment where cable assembly 10 is prepared for coupling to or plugging into an optical receptacle to create a mechanical coupling for optical data transmission between the cable assembly 10 and the optical receptacle. As depicted in FIG. 1, the cable assembly 10 is connectorized with a first connector 12 at a first end 11a and a second connector 14 at a second end 11b. A length of optical fiber cable 16 extends between the first connector 12 and the second connector 14. In one or more embodiments, the optical fiber cable 16 has a length of up to 100 m, in particular about 0.5 m to about 50 m. In such embodiments, a short length of connectorized cable can be described as a “patchcord,” where patchcord(s) are often used for signal routing between receptacles in optical equipment separated by short distances (e.g., within a terminal box or within a data center).

FIG. 2 depicts a cross-section of a first embodiment of the optical fiber cable 16. The optical fiber cable 16 includes a cable jacket 18 having an inner surface 20 and an outer surface 22. In one or more embodiments, the outer surface 22 is the outermost surface of the optical fiber cable 16, and the outer surface 22 defines a maximum cross-sectional dimension Dc (e.g., diameter) of the optical fiber cable 16. In some embodiments, the maximum cross-sectional dimension Dc is at most 5 mm, at most 3 mm, or at most 2 mm. In some embodiments, the maximum cross-sectional dimension Dc is at least 1 mm. Further, the inner surface 20 defines a central bore 24 that extends along a longitudinal axis 25 (denoted by an “x” at the center of the central bore 24) of the optical fiber cable 16. The inner surface 20 and the outer surface 22 define a thickness T therebetween. In some embodiments, the thickness T is from 0.1 mm to 1 mm, in particular from 0.1 mm to 0.7 mm, and most particularly from 0.2 mm to 0.5 mm.

Disposed within the central bore 24 of the cable 16 is at least one optical element 26. In one or more embodiments, the optical element 26 may be, e.g., one or more bare optical fibers (which may include an outer color coating layer) or tight buffered fibers (which have an outer polymer coating). In one or more embodiments, the cable 16 includes from one to twelve optical elements 26. In the embodiment depicted in FIG. 2, there are two optical elements 26 disposed within the central bore 24 of the cable 16. The two optical elements 26 of FIG. 2 are depicted, in particular, in a loose tube configuration in which free space is provided around the optical elements 26 within the central bore 24. However, it is within the scope of the present disclosure that in alternate embodiments, alternate configurations of optical elements 26 within central bore 24 can be used.

The cable 16 includes one or more tensile strands 28 embedded in the cable jacket 18 between the inner surface 20 and the outer surface 22. In embodiments, the tensile strands 28 comprise yarns or filaments. In embodiments, the tensile strands 28 are made of at least one of glass, basalt, or a polymer, such as ultra high molecular weight polyethylene or polyester. In one or more embodiments, the tensile strands 28 are made from a polymer having an elastic modulus (Young's modulus) of 30 GPa or higher. Advantageously, these materials are relatively less expensive than conventionally-used aramid strands, while providing the same or better tensile properties. Moreover, glass and basalt strands are essentially inert to fire at the typical fire exposure temperatures. That is, these materials are non-combustible at the typical fire exposure temperatures of about 350° C. to about 700° C., and therefore, these materials do not contribute to the calorimetric decomposition process. Previously, the comparatively low shear strength of these materials, especially glass and basalt, prevented them from use as tensile strands in patchcord cable designs. For example, the low shear strength could cause breakage of the strands 28 when the cable 16 is pulled around corners in ducts or when attaching a connector to an end of the cable. However, in accordance with the present disclosure, by embedding the tensile strands 28 in the cable jacket 18, the polymeric material of the cable jacket 18 acts as a buffer against the shear stresses on the tensile strands 28 to mitigate the low shear strength properties of strands 28 and thereby allow the use of tensile strands 28 within cable 16. In particular, the cable jacket 18 changes the load distribution of shear forces on the tensile strands 28 by cushioning the tensile strands 28 against the shear forces created when a crimp ring attaches the cable jacket 18 to a connector. Previously, the crimp ring directly contacted the tensile strands during connectorization, and thus by providing an intermediate layer of the polymer of the cable jacket 18 according to the present disclosure, the shear forces on the tensile strands 28 are reduced.

In one or more embodiments, the cable jacket 18 includes from one to ten tensile strand 28, in particular three to six tensile strands 28. In some embodiments, the cable jacket includes at least three tensile strands 28 so as to avoid creating a preferential bend direction for the optical fiber cable 16. In one or more embodiments, the tensile strands 28 are equidistantly spaced in a ring within the cable jacket 18. However, it is within the scope of the present disclosure that in alternate embodiments, alternate configurations of tensile strands 28 within cable 16 may be used.

In one or more embodiments, the optical fiber cable 16 is constructed to satisfy various criteria related to burn performance (e.g., plenum-rated in the U.S., construction products regulation in Europe, including EN 61054). In such embodiments, the cable jacket 18 is composed of a low-smoke, zero halogen (LSZH) polymeric compound. In some embodiments, LSZH polymeric compounds may include intumescent flame retardant packages and/or various flame retardant filler materials. In some embodiments, an intumescent flame retardant package may include a carbon source, an acid source, and, optionally, a specific compound, and examples of flame retardant filler materials are aluminum trihydrate (ATH) and magnesium dihydride (MDH). Moreover, in terms of burn performance, the above-listed materials for the tensile strands 28 are considered low acid materials, as compared to conventionally-used aramid tensile elements. Thus, the cable 16 also meets acidity requirements according to such standards as EN 61054.

FIG. 2 depicts tensile strands 28 that have substantially round cross-sections. In such embodiments, the tensile strands 28 have a maximum cross-sectional dimension D_{S} of 0.05 mm to 0.2 mm. In FIG. 2, the tensile strands 28 are depicted as being circular, and thus, the maximum cross-sectional dimension D_{S} is a diameter. As mentioned above, the tensile strands 28 may be single filaments or yarns comprised of multiple filaments. In one or more embodiments, tensile strands 28 have a linear density of at least 400 dtex, at least 800 dtex, or at least 1580 dtex. Further, in embodiments, the linear density of the tensile strands 28 is up to 2000 dtex. It is within the scope of the present disclosure that in alternate embodiments, tensile strands 28 may have cross sections in alternate shapes (e.g., oval, ellipse, diamond, rectangle, square, triangle, multi-lobed, hexagon, octagon, etc., including hollow versions and versions of the polygonal shapes with rounded vertices). In such alternate embodiments, the maximum cross-sectional dimension D_{S} may still be in the range of 0.05 to 0.2 mm.

FIG. 3 depicts an alternate embodiment of an optical fiber cable 16. As shown, the cable jacket 18 is tightly fitted around a single optical element 26. In some embodiments, such as the embodiment depicted, the inner surface 20 of the cable jacket 18 contacts the optical element 26. In such embodiments, the optical element 26 may be a bare optical fiber, and the cable jacket 18 acts similarly to a tight-buffer tube. Otherwise, optical fiber cable 16 is substantially similar to the optical fiber cable 16 of FIG. 2. In particular, the optical fiber cable 16 shown in FIG. 3 includes tensile strands 28 embedded between the inner surface 20 and the outer surface 22 of the cable jacket 18. Further, in embodiments, the tensile strands 28 are comprised of filaments or yarns of basalt, a glass, a polyester, an ultra high molecular weight polyethylene, or a polymer having an elastic modulus of at least 30 MPa.

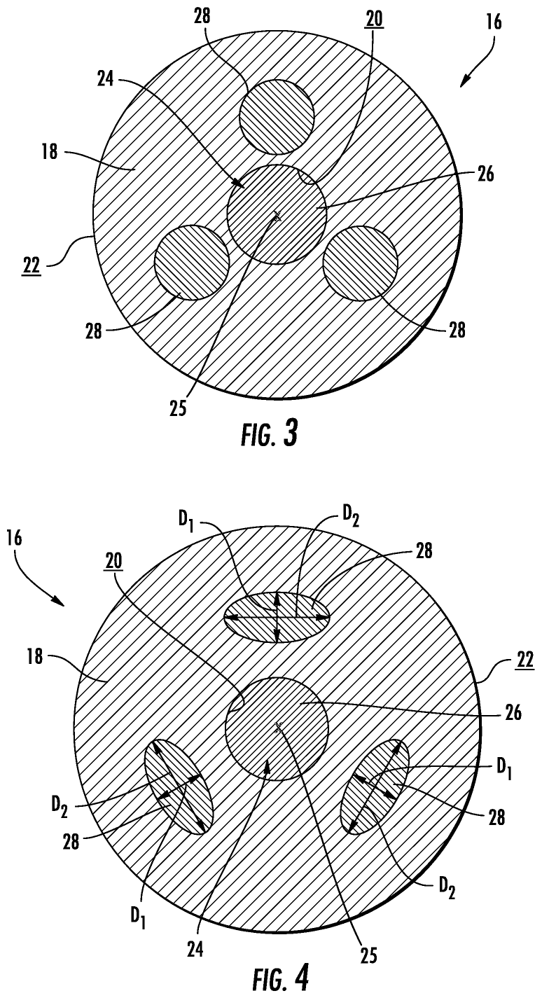

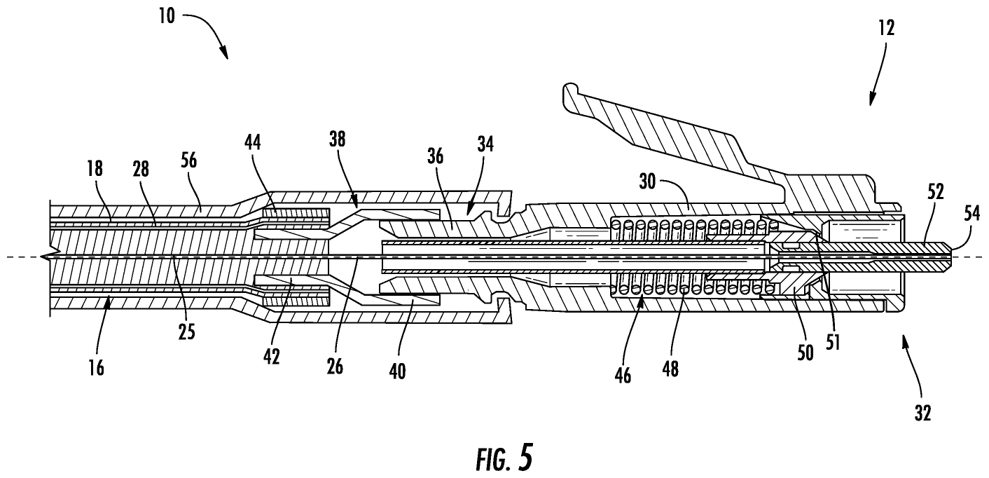

FIG. 4 depicts an alternate embodiment of an optical fiber cable 16 in which the tensile strands 28 are non-circular. In particular, tensile strands 28 are flattened, e.g., into an oval shape or an elliptical shape. In some embodiments, the tensile strands 28 are flattened by tensioning the tensile strands 28 during extrusion of the cable jacket 18. In other embodiments, the flattened tensile strands 28 are a series of adjacent filaments (e.g., two, three, four, five, or more filaments arranged next to each other).

As shown, the tensile strands 28 have a first cross-sectional dimension D₁ and a second cross-sectional dimension D₂. As shown in FIG. 4, the first cross-sectional dimension D₁ is radial to the longitudinal axis of the optical fiber cable 16, and the second cross-sectional dimension D₂ is measured transversely, in particular perpendicular, to the first cross-sectional dimension D₁. In one or more embodiments, the second cross-sectional dimension D₂ is larger than the first cross-sectional dimension. In some embodiments, the second cross-sectional dimension D₂ is at least 1.25, at least 1.5, at least 1.75, or at least 2 times larger than the first cross-sectional dimension D₁. In some embodiments, the second cross-sectional dimension D₂ is up to 5 times larger than the first cross-sectional dimension D₂. However, it is within the scope of the present disclosure that in alternate embodiments, the first cross-sectional dimension D₁ is greater than the second cross-sectional dimension D₂.

Referring now to FIG. 5, FIG. 5 depicts a cross-section of a connector, such as the first connector 12, connected to the optical fiber cable 16, of cable assembly 10. While the first connector 12 is depicted, FIG. 5 may also be representative of the second connector 14; although, in other embodiments, the second connector 14 may be of a different type than the first connector 12. Notwithstanding, the connection of the cable jacket 18 to the end of the connector will be substantially the same as described in relation to FIG. 5.

As shown in FIG. 5, the first connector 12 includes a connector housing 30. The connector housing 30 has a first end 32 and a second end 34. The first end 32 is configured for insertion into an optical receptacle (e.g., a terminal port, adaptor, or coupler for an LC, SC, FC, or ST connector, amongst other possibilities). The optical fiber cable 16 is connected to the second end 34 of the connector housing 30. The second end 34 of the connector housing 30 includes a sleeve 36 through which the optical element 26 of the optical fiber cable 16 is inserted. In some embodiments, the sleeve 36 may include a threaded, knurled, or roughened surface to provide an engagement surface against which the crimp band 38 (first ring section 40 of crimp band 38 as described below) is crimped against. A crimp band 38 engages with sleeve 36 where crimp band 38 includes a first ring section 40 and a second ring section 42. The first ring section 40 is configured to engage an outer surface of the sleeve 36.

As mentioned above, the crimp band 38 also includes a second ring section 42 configured to engage the optical fiber cable 16. In some embodiments, the second ring section 42 is inserted into the cable jacket 18 of the optical fiber cable 16. In such embodiments, the cable jacket 18 may be split to accommodate the second ring section 42 within the interior of the cable jacket 18. The cable jacket 18 is held on the second ring section 42 by a crimp ring 44. The crimp ring 44 is compressed around the cable jacket 18 and against the second ring section 42 to hold the cable jacket 18 onto the crimp band 38. In some embodiments, the crimp ring 44 is heated to enhance the joint between the crimp ring 44, cable jacket 18, and the second ring section 42. In such embodiments, the crimp ring 44 is heated to a temperature ranging between 10° C. and 20° C. below the melting temperature of the polymeric compound of the cable jacket 18. Further, in some embodiments, the second ring section 42 may define a hose barb fitting, and the crimp ring 44 may define a hose clamp, which may provide a secure connection for the cable jacket 18 over the second ring section 42.

Tensile strands 28 have a length that is substantially equal to or greater than a length of the cable jacket 18. As used herein, “substantially equal to a length of the cable jacket” refers to a length of the tensile strands 28 in the cable jacket 18 such that, when the optical fiber cable 16 is connected to the second end 34 of the connector housing 30, the crimp ring 44 engages a section of the cable jacket 18 incorporating the tensile strands 28.

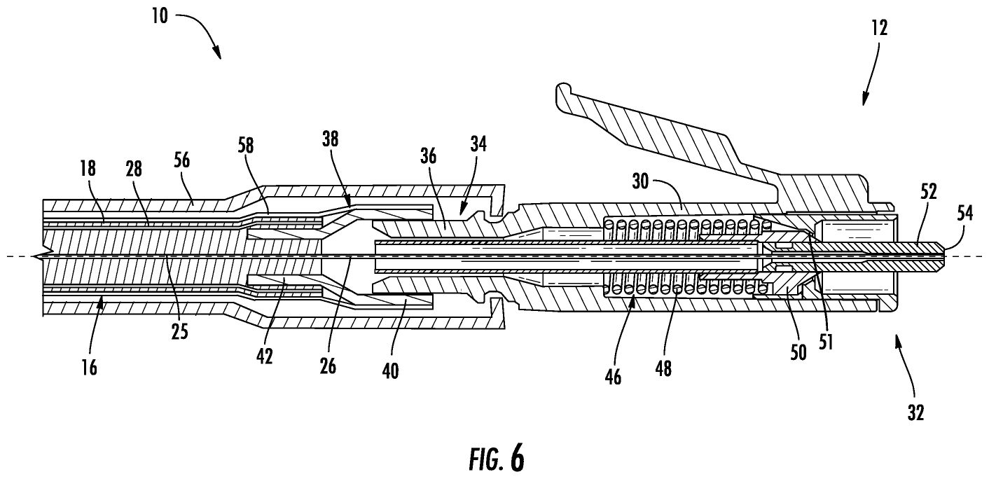

In other embodiments, such as shown in FIG. 6, the cable jacket 18 may be provided on either the interior or exterior of the second ring section 42, and a heat shrink tube 58 may be provided around the cable jacket 18 and the second ring section 42 and/or the first ring section 40 to join the optical fiber cable 16 to the crimp band 38. In still other embodiments, the cable jacket 18 may be glued to the second ring section 42 of the crimp band 38.

As shown in FIGS. 5 and 6, the connector housing 30 has an interior chamber 46 in which a spring 48 and a ferrule holder 50 are disposed. The interior chamber 46 includes an abutment surface 51 against which the spring 48 pushes the ferrule holder 50, which is configured to hold a ferrule 52. The optical element 26 extends into the ferrule 52 and is held in a bore of the ferrule 52 by a bonding agent. The ferrule 52 includes a connector surface or ferrule end face 54, and the optical element 26 terminates at the connector surface 54 of the ferrule 52. In some embodiments, optical element 26 terminates substantially flush with connector surface 54 of ferrule 52. However, it is within the scope of the present disclosure that alternate configurations of optical element 26 and connector surface 54 when optical element 26 is terminated may be used, e.g., optical element 26 is angled with respect to connector surface 54 of ferrule 52. When the first connector 12 is inserted into a receptacle, the ferrule 52 is configured to position the optical element 26 such that transmission losses are minimized at the interface between the optical element 26 of the optical fiber cable 16 and the optical element of the receptacle. To ensure a close engagement between the optical element 26 of the optical fiber cable 16 and the optical element of the receptacle, the ferrule 52 is pushed into contact with the receptacle by the force of the spring 48 on the ferrule holder 50. Further, as shown in FIGS. 5 and 6, a connector boot 56 is optionally slid over a portion of the cable jacket 18, the crimp ring 44 or the heat shrink tube 58, the crimp band 38, and the sleeve 36 to protect and provide additional stiffness to the connection between the optical fiber cable 16 and the first connector 12. In contrast to conventional cable designs, the cable jacket 18 having tensile strands 28 embedded therein provide sufficient stiffness that the connector boot 56 may be dispensed with in certain embodiments.

Having described the structure of the connection between the optical fiber cable 16 and the first connector 12, a method of preparing a cable assembly 10 is described. As mentioned previously, the present disclosure pertains to attaching the first connector 12 to a first end 11a of the optical fiber cable 16, but the present disclosure also applies to attaching the second connector 14 to the opposite end 11b of the optical fiber cable 16.

In a first step, the connector boot 56 (if included) and crimp ring 44 are slid over the cable jacket 18 from the terminal end of the optical fiber cable 16. In a second step, the cable jacket 18 is stripped from the end of the optical fiber cable 16 to expose the optical element 26. Further, any coatings (such as a tight buffer coating) on the optical element 26 are stripped away. In a third step, connector 12 is assembled by inserting and bonding the stripped optical element 26 into the ferrule 52, and the ferrule 52 is inserted into the connector housing 30 of the first connector 12. Further, the first ring section 40 of the crimp band 38 is attached to the sleeve 36 of the connector housing 30. In a fourth step, the cable jacket 18 is split so that the second ring section 42 of the crimp band 38 can be inserted into the cable jacket 18. In embodiments, the length of the split is from about 7 mm to about 10 mm. In a fifth step, the split cable jacket 18 is wrapped around the second ring section 42 of the crimp band 38, the crimp ring 44 is slid over the cable jacket 18, and the crimp ring 44 is crimped to compress the cable jacket 18 against the second ring section 42. Optionally, the crimp ring 44 is heated to a temperature ranging between 10° C. and 20° C. below the melting temperature of the polymer of the cable jacket 18 before crimping, which improves adhesion between the cable jacket 18 and the crimp ring 44 and between the cable jacket 18 and the second ring section 42 of the crimp band 38. In embodiments, heating can be performed by applying heat onto to the crimp ring 44. In some embodiments, a torch is used to apply heat, and in other embodiments, a tool that crimps the crimp ring 44 may heat the crimp ring 44 during the heating step. In a final step, the connector boot 56 (if included) is slid over the second end 34 of the connector housing 30.

In embodiments in which a heat shrink tube 58 (as shown in FIG. 6) is used, the heat shrink tube 58 may be slid over the cable jacket 18 in the first step, and in the fourth and fifth steps, the cable jacket 18 may not need to be split, and the cable jacket 18 may instead be inserted into the second ring section 42 of the crimp band 38. Further, in the fifth step, a heat gun or torch is used to cause the heat shrink tube 58 to shrink around the cable jacket 18 and crimp band 38.

Advantageously, the cable assembly 10 according to the present disclosure is believed to be able to meet relevant performance standards, such as IEC 60794-2-50 for example. According to such standards, the optical fiber cable 16 of the cable assembly 10 must be able to withstand tensile loads up to 200 N (for optical fiber cables 16 having a 2 mm outer diameter) while not exceeding a fiber strain of 0.6% when the load is applied short term e.g. during installation. Further, the cable assembly 10 according to the present disclosure is believed to be able to meet the requirements of connectorized cables given in IEC 61300-2-4 in which a cable with an outer diameter of up to 2 mm must with stand a maximum load of 50 N applied between the optical fiber cable 16 and the optical receptacle for 120 seconds.

According to one or more embodiments of the present disclosure, the optical fiber cable 16 is prepared by extruding the polymeric cable jacket material with the tensile strands. The extrusion die (not shown) includes a plurality of apertures (not shown) configured to position the tensile elements 28 within the cable jacket 18. Further, the apertures of the extrusion die can be configured to flatten out the tensile strands 28 based on the width of the apertures. Additionally, the tensile strands 28 can be extruded under tension to flatten the tensile strands 28.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A cable assembly, comprising:
an optical fiber cable, comprising:
a cable jacket having a length, an inner surface, and an outer surface, the inner surface defining a central bore extending along a longitudinal axis of the optical fiber cable and the outer surface defining an outermost surface of the optical fiber cable;
at least one tensile strand disposed between the inner surface and the outer surface of the cable jacket, wherein the at least one tensile strand has a length that is substantially equal to or greater than the length of the cable jacket;
at least one optical element disposed within the central bore of the cable jacket.

2. The cable assembly of claim 1, wherein each of the at least one tensile strand comprises a glass, basalt, a polyester, an ultra high molecular weight polyethylene, or a polymer having an elastic modulus of at least 30 GPa.

3. The cable assembly of claim 1, wherein the at least one tensile strand comprises from three to ten tensile strands.

4. The cable assembly of claim 1, wherein the outer surface of the cable jacket defines a maximum cross-sectional dimension of the optical fiber cable and wherein the maximum cross-sectional dimension is 5 mm or less.

5. The cable assembly of claim 1, wherein the optical element comprises a bare optical fiber or a tight-buffered optical fiber.

6. The cable assembly of claim 1, wherein the at least one optical element is a single optical fiber and wherein the inner surface of the cable jacket contacts the single optical fiber.

7. The cable assembly of claim 1, wherein each of the at least one tensile strand comprises a first cross-sectional dimension and a second cross-sectional dimension, wherein the first cross-sectional dimension is measured radially with respect to the longitudinal axis, wherein the second cross-sectional dimension is measured transversely to the first cross-sectional dimension, and wherein the second cross-sectional dimension is larger than the first cross-sectional dimension.

8. The cable assembly of claim 7, wherein the second cross-sectional dimension is at least 1.25× the first cross-sectional dimension.

9. The cable assembly of claim 1, wherein each of the at least one tensile strand comprises a linear density of 400 dtex to 2000 dtex.

10. The cable assembly of claim 1, wherein each of the at least one tensile strand comprises a maximum cross-sectional dimension of 0.05 mm to 0.2 mm.

11. The cable assembly of claim 1, further comprising a first connector attached to an end of the optical fiber cable, wherein the first connector comprises:
a connector housing having a first end and a second end, the first end configured to be inserted into an optical receptacle and the second end comprising a sleeve;
a crimp band having a first ring section and a second ring section;
wherein the first ring section engages the sleeve of the connector housing and the second ring section engages the optical fiber cable; and
wherein the at least one optical element extends through the connector housing from the first end to the second end.

12. The cable assembly of claim 11, wherein the cable jacket having the at least one tensile strand embedded therein is compressed between the second ring section of the crimp band and a crimp ring.

13. A method of preparing a cable assembly, the method comprising:
inserting at least one optical element of an optical fiber cable through a connector housing;
connecting a first ring section of a crimp band to a sleeve of the connector housing;
connecting a second ring section of the crimp band to a cable jacket of the optical fiber cable, wherein a plurality of tensile strands are embedded within the cable jacket and wherein the cable jacket has a length and defines a central bore of the optical fiber cable in which the at least one optical element is disposed.

14. The method of claim 13, wherein connecting the second ring section to the cable jacket comprises:
inserting the second ring section into the cable jacket;
crimping a crimp ring around the cable jacket such that the cable jacket is compressed between the crimp ring and the second ring section.

15. The method of claim 14, further comprising splitting the cable jacket before inserting the second ring section into the cable jacket.

16. The method of claim 14, further comprising heating the crimp ring before crimping the crimp ring around the cable jacket.

17. The method of claim 16, wherein the crimp ring is heated to a temperature ranging between 10° C. and 20° C. below a melting temperature of the cable jacket.

18. The method of claim 13, wherein connecting the second ring section to the cable jacket comprises:
inserting the cable jacket into the second ring section or inserting the second ring section into the cable jacket; and
shrinking a heat shrink tube over the cable jacket and the second ring section.

19. The method of any of claim 14, wherein each of the plurality of tensile strands has a length that is substantially equal to or greater than the length of the cable jacket.

20. The method of claim 13, wherein at least one tensile strand of the plurality of tensile strands comprises at least one of basalt, a glass, a polyester, an ultra high molecular weight polyethylene, or a polymer having an elastic modulus of at least 30 GPa; and
wherein the cable jacket comprises an outer surface defining an outermost surface of the optical fiber cable and a maximum cross-sectional dimension of the optical fiber cable, the maximum cross-sectional dimension being 5 mm or less.
